(19) United States
(12) Patent Application Publication
(10) Pub. No.: US 2013/0106775 A1
(43) Pub. Date: May 2, 2013

(54) INPUT/OUTPUT UNIT OF MOBILE TERMINAL AND A DRIVING METHOD THEREOF

(71) Applicant: Dong-Hyun YOO, Gyeonggi-do (KR)

(72) Inventor: Dong-Hyun YOO, Gyeonggi-do (KR)

(73) Assignee: SAMSUNG ELECTRONICS CO., LTD., Gyeonggi-do (KR)

(21) Appl. No.: 13/592,690

(22) Filed: Aug. 23, 2012

(30) Foreign Application Priority Data
Oct. 27, 2011 (KR) 10-2011-0110510

(51) Int. Cl. G06F 3/044; G06F 3/041; G06F 3/045

(52) U.S. Cl. 345/174; 345/173

(57) ABSTRACT

An input/output unit of a mobile terminal includes a touchscreen and a controller. The touchscreen unit includes a display and a combination of a resistive touch panel and a capacitive touch panel stacked on the display. The controller communicates with the touchscreen unit and controls to selectively drive one of the resistive touch panel and the capacitive touch panel.

### CLAIM OF PRIORITY

This application claims, pursuant to 35 U.S.C. §119(a), priority to and the benefit of the earlier filing date of a Korean patent application filed in the Korean Intellectual Property Office on Oct. 27, 2011 and assigned Serial No. 10-2011-0110510, the entire disclosure of which is hereby incorporated by reference.

### BACKGROUND OF THE INVENTION

1. Field of the Invention

The present invention relates to an input/output unit of a mobile terminal and a driving method thereof

2. Description of the Related Art

Recently, due to the development of electronic communication industries, a mobile terminal has become a necessity of modern society and serves as an important means for transferring fast changing information. Therefore, companies competitively develop mobile terminals having even more convenient functions in order to secure more users. Furthermore, due to the development and popularization of a Graphic User Interface (GUI) system, a touchscreen is generally used for mobile terminals.

The touchscreen has a configuration in which a touch panel is attached to a display such as a Liquid Crystal Display (LCD). The touch panel may be classified into a resistive touchscreen and a capacitive touchscreen, as well as other known types of touchscreens. The resistive touch panel is formed by densely installing sensor lines that react to pressure applied to a screen surface and detects a position with a coordinate when pressure is applied. In contrast, the capacitive touch panel detects a touched place by providing an electrical charge and detecting a degree of lost charge upon touch.

It is known that the resistive touch panel and the capacitive touch panel have advantages and disadvantages compared with each other. Generally, the conventional mobile terminal in the prior art applies only one of the resistive touch panel and the capacitive touch panel, and this causes a necessity of incorporating the other type of touch panel. For example, a user cannot manipulate the capacitive touchscreen of a mobile terminal with a gloved hand. Furthermore, recently, as functions of a mobile terminal have also diversified, a touch panel that is advantageous to providing diversified functions is required.

### SUMMARY OF THE INVENTION

An aspect of the present invention is to address at least the above-mentioned problems and/or disadvantages and to provide at least the advantages described below. Accordingly, an aspect of the present invention is to provide a mobile terminal that can provide both a resistive touchscreen and a capacitive touchscreen.

Another aspect of the present invention is to provide an input/output unit of a mobile terminal and a driving method thereof, for adding a resistive touch panel and a capacitive touch panel to a display, and selectively driving one of the touch panels depending on a predetermined circumstance of use of the mobile terminal

In accordance with an aspect of the present invention, an input/output unit of a mobile terminal is provided. The unit includes a touchscreen unit including a display, with a resistive touch panel and a capacitive touch panel stacked on the display, and a controller for communicating with the touchscreen unit and controlling to selectively drive one of the resistive touch panel and the capacitive touch panel.

In accordance with another aspect of the present invention, a method is provided for selectively driving a touch panel in a mobile terminal having a touchscreen unit including a display and two touch panels stacked on the display. The method includes determining whether there is a predetermined circumstance defined in advance, and driving a touch panel designated for the circumstance defined in advance.

Other aspects, advantages and salient features of the present invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features and advantages of certain exemplary embodiments of the present invention will be more apparent from the following description taken in conjunction with the accompanying drawings in which:

FIG. 1 is a perspective view illustrating a mobile terminal according to an exemplary embodiment of the present invention;

FIG. 2 is a block diagram illustrating the mobile terminal according to the exemplary embodiment of the present invention; and

FIG. 3 is a flowchart illustrating a procedure for selectively driving a relevant touch panel in a mobile terminal according to the exemplary embodiment of the present invention.

Throughout the drawings, like reference numerals will be understood to refer to like parts, components and structures.

### DETAILED DESCRIPTION OF THE INVENTION

The following description with reference to the accompanying drawings is provided to assist in a comprehensive understanding of preferred embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

This invention may, however, be embodied in many different forms and should not be construed as limited to the exemplary embodiments set forth herein. The same reference numbers are used throughout the drawings to refer to the same or like parts. Also, terms described herein, which are defined considering the functions of the present invention, may be implemented differently depending on user and operator's intention and practice. Therefore, the terms should be understood on the basis of the disclosure throughout the specification.

Furthermore, although the drawings represent exemplary embodiments of the invention, the drawings are not necessarily to scale and certain features may be exaggerated or omitted in order to more clearly illustrate and explain the present invention.

Among the terms set forth herein, a terminal refers to any kind of device capable of processing data which is transmitted or received to or from any external entity. The terminal may display icons or menus on a screen to which stored data and various executable functions are assigned or mapped. The terminal may include a computer, a notebook, a tablet PC, a mobile device, and the like.

Among the terms set forth herein, a screen refers to a display or other output devices which visually display information to the user, and which optionally are capable of receiving and electronically processing tactile inputs from a user using a stylo, a finger of the user, or other techniques for conveying a user selection from the user to the output devices.

Among the terms set forth herein, an icon refers to a graphical element such as a figure or a symbol displayed on the screen of the device such that a user can easily select a desired function or data. In particular, each icon has a mapping relation with any function being executable in the device or with any data stored in the device and is used for processing functions or selecting data in the device. When a user selects one of the displayed icons, the device identifies a particular function or data associated with the selected icon. Then the device executes the identified function or displays the identified data.

Among terms set forth herein, data refers to any kind of information processed by the device, including text and/or images received from any external entities, messages transmitted or received, and information created when a specific function is executed by the device.

Exemplary embodiments of the present invention provide an input/output unit of a mobile terminal and a driving method thereof, for adding at least two touch panels, such as a resistive touch panel and a capacitive touch panel to a display, and selectively driving one of the touch panels depending on a predetermined circumstance of use of the mobile terminal.

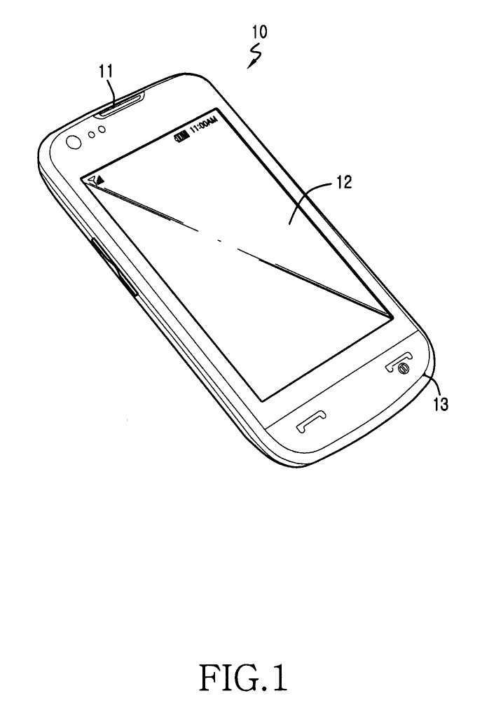

FIG. 1 is a perspective view illustrating a mobile terminal according to an exemplary embodiment of the present invention.

Referring to FIG. 1, the mobile terminal 10 includes a speaker 11 for outputting sound based on an electrical signal for audio, a touchscreen 12 for outputting an image based on an electrical signal for visual images, and for receiving a touch which is converted to a touch electrical signal, and a microphone 13 for converting sound into another audio electrical signal.

In particular, the touchscreen 12 according to the exemplary embodiment of the present invention has a configuration in which a resistive touch panel and a capacitive touch panel are stacked on a display such as an LCD. It is understood that other know types of touch panels may be included in a combination of two or more different types of touch panels, such as resistive and capacitive touch panels, stacked on the display. The mobile terminal 10 selectively drives one of the two touch panels depending on a predetermined circumstance of use of the mobile terminal 10. For example, the mobile terminal 10 may allow a user to perform a process for correlating an application with a relevant type of touch panel. The process is not limited thereto but a touch panel type correlated with an application may be defined by a manufacturer. Therefore, when a specific application is executed, a touch panel type correlated in advance among the two types of touch panels, for use with the specific application, is automatically driven. For example, in the case of executing a figure drawing function, the mobile terminal 10 selectively drives the capacitive touch panel correlated in advance that allows a smooth touch during use of the figure drawing function, as compared to the resistive touch panel. In the case where a web page and/or icons on the GUI are displayed, the mobile terminal selectively drives the capacitive touch panel correlated in advance where scroll and magnification are relatively easy. Furthermore, the mobile terminal 10 has a sensor unit that can calculate an external factor such as temperature, humidity, etc., and drives one of the two types of touch panels depending on a value measured by the sensor unit. For example, in a cold weather environment defined as having a specific ambient temperature or below, the mobile terminal 10 drives the resistive touch panel, and a user may perform a touch input even when the user is gloved. A setting for driving one of the two touch panels depending on each circumstance may be defined by a user.

A person of ordinary skill in the art would arrange the capacitive touch panel and the resistive touch panel with consideration of the following. The capacitive touch panel may be put on top of the resistive touch panel, or vice versa. However, generally, since the capacitive touch panel detects a touch only when a conductor is touched, the capacitive touch panel may be put on top of the resistive touch panel and so the capacitive touch panel is externally exposed while covering the resistive touch panel. The configuration is not limited thereto, and so the resistive touch panel may alternatively be put on top of the capacitive touch panel. For example, in the case where sensitivity is controlled such that a touch is detected even when a conductor does not contact the capacitive touch panel, the capacitive touch panel does not need to be put on top of the resistive touch panel. Furthermore, in the case where touch detection via the resistive touch panel is required in the configuration where the capacitive touch panel is put on top of the resistive touch panel, the capacitive touch panel may be physically pressed and damaged. In view of such considerations, it may be preferable to put the resistive touch panel on the capacitive touch panel. Furthermore, a degree of pressing force transferred to the resistive touch panel may be ineffective or a pressing position may be inaccurate in the configuration where the capacitive touch panel is put on top of the resistive touch panel. In view of such additional considerations, it may be preferable to put the resistive touch panel on top of the capacitive touch panel.

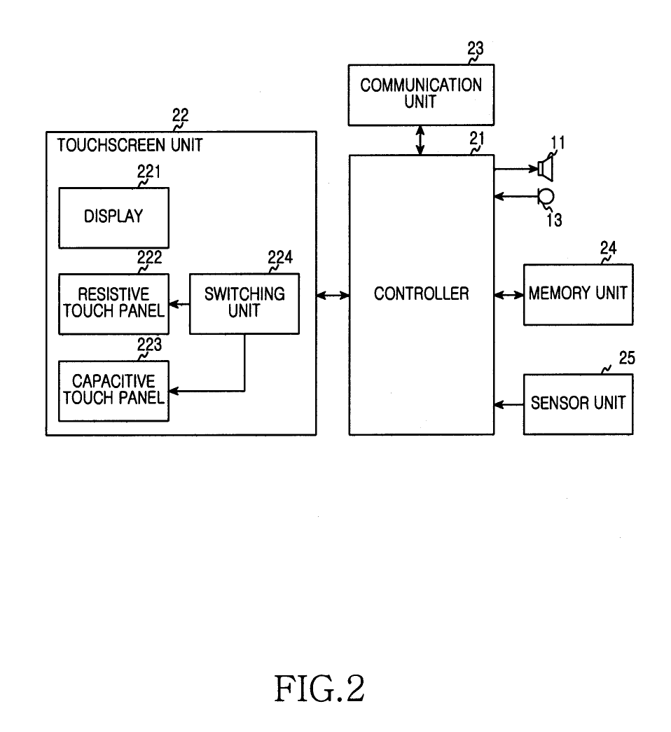

FIG. 2 is a block diagram illustrating the mobile terminal according to the exemplary embodiment of the present invention.

Referring to FIG. 2, the mobile terminal 10 includes a controller 21, a touchscreen unit 22, a communication unit 23, a memory unit 24, a sensor unit 25, a speaker 11, and a microphone 13. The controller 21 controls an overall operation of the mobile terminal 10. The controller 21 sets execution environments and conditions of the mobile terminal 10, maintains information thereof, allows the mobile terminal 10 to operate stably, and allows data input/output exchange of all units of the mobile terminal 10 to be swiftly performed. Furthermore, the controller 21 may perform a relevant communication service function via the communication unit 23. In addition, the controller 21 may include a codec for converting signals regarding image and voice inputs and outputs via the touchscreen unit 22, the speaker 11, and the microphone 13.

The touchscreen unit 22 includes a display 221 for outputting an image corresponding to an image electrical signal received from the controller 21, a resistive touch panel 222 stacked on top of the display 221 and outputting a first touch signal, corresponding to a resistive touch, to the controller 21, and a capacitive touch panel 223, stacked on top of the resistive touch panel 222, for outputting a second touch signal, corresponding to a capacitive touch, to the controller 21. Furthermore, the touchscreen unit 22 further includes a switching unit 224 for switching the detection of touches to the resistive touch panel 222 or to the capacitive touch panel 223 under control of the controller 21. The display 221 may be an LCD, a plasma display, etc.

The mobile terminal 10 further includes a sensor unit 25 corresponding to an external detection object. For example, the sensor unit 25 measures temperature and humidity and outputs sensor electrical signals to the controller 25 representing such sensed temperature and/or humidity measurement values, and the controller 25 drives a relevant touch panel 222, 223 when a measurement value provided by the sensor unit 25 reaches a predetermined threshold. For example, if the sensor unit 25 detects an ambient temperature at or below the threshold, the controller 25 drives the resistive touch panel 222, but if the sensor unit 25 detects an ambient temperature above the threshold, the controller 25 drives the capacitive touch panel 223. In another example, the sensor unit 25 outputs a sensor electrical signal corresponding to proximity of a conductor to the controller 21, and the controller 21 drives a relevant touch panel 222, 223. In the case of a configuration in which the capacitive touch panel 223 is put on top of the resistive touch panel 222, an erroneous touch may be generated when a user closely touches the capacitive touch panel 223 of the mobile terminal 10 during unrelated communications or activities, such as by talking on the mobile terminal 10. Therefore, when proximity is recognized during such communications via the sensor unit 25, the controller 21 switches to the resistive touch panel 222 so that the capacitive touch panel 223 is not driven, and so erroneous capacitive touch signals are not generated. Furthermore, although described above, in the case of a configuration where the capacitive touch panel 223 is positioned below the resistive touch panel 222, the controller 21 controls sensitivity of the capacitive touch panel 223 to detect a touch even when a conductor does not contact the capacitive touch panel 223.

Consequently, the controller 21 drives a relevant touch panel depending on the circumstances of use of the mobile terminal 10, such as an operation of a specific function, and reception of a signal from the sensor unit 25. The controller 21 basically drives a first touch panel, controls to switch to a second touch panel upon determining existence of a predetermined circumstance when the second touch panel is driven, and when the predetermined circumstance ends, switches back to the original first touch panel. The operation of the controller 21 is not limited thereto but the controller 21 may maintain the switched second touch panel as the currently driven touch panel.

The memory unit 24 stores data regarding operations of the mobile terminal 10, and the controller 25 loads relevant information from the memory unit 24 to perform an operation according to the exemplary embodiment of the present invention.

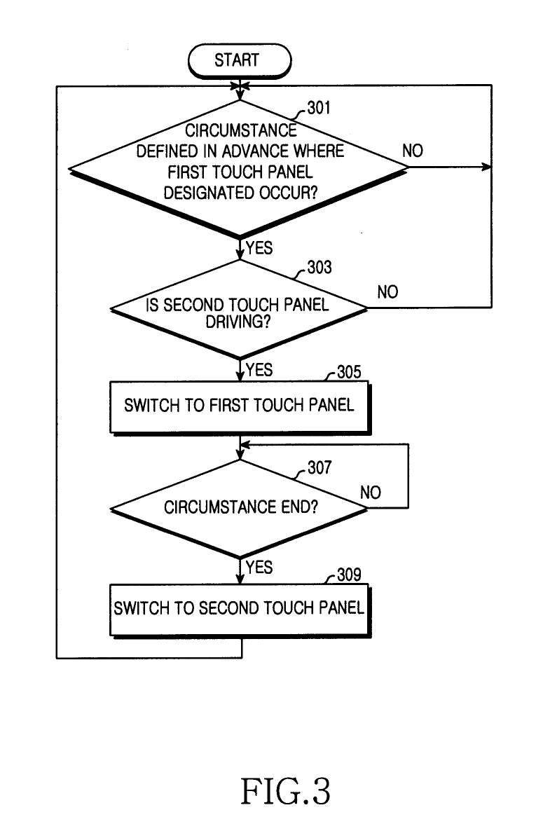

Hereinafter, a method for selectively driving, at the controller 21, the relevant touch panel according to the exemplary embodiment of the present invention is described with reference to FIG. 3.

FIG. 3 is a flowchart illustrating a procedure for selectively driving the relevant touch panel in the mobile terminal 10 according to the exemplary embodiment of the present invention.

Referring to FIG. 3, the controller 21 determines whether a first touch panel is relevant to a designated predetermined circumstance in step 301.

When determining that the first touch panel is relevant to the designated predetermined circumstance, the controller 21 determines whether a second touch panel is being driven in step 303. When determining that the second touch panel is not being driven, that is, the first touch panel is being driven in step 303, the controller 21 does not perform switching, by the switching unit 224, to the second touch panel but maintains driving of the first touch panel. When determining that the second touch panel is being driven in step 303, the controller 21 controls the switching unit 224 to switch to the first touch panel in step 305.

After that, the controller 21 determines whether the circumstance ends in step 307. When determining that the circumstance ends, the controller 21 controls the switching unit 224 which switches back to the second touch panel in step 309, and loops back to step 301 to perform subsequent steps after step 301. The operation of the controller 21 is not limited thereto but the controller 21 may maintain the switched second touch panel as the current touch panel being driven, and perform subsequent steps after step 301.

Consequently, an input/output unit of a mobile terminal 10 and a driving method thereof according to the present invention implements the advantages of each type of touch panel and provides an input/output mutually avoiding the disadvantages of each type of touch panel by using an advantageous touch panel depending on and relevant to a current circumstance of use of the mobile terminal 10.

The above-described apparatus and methods according to the present invention can be implemented in hardware, firmware or as software or computer code that can be stored in a recording medium such as a CD ROM, a RAM, a ROM, a floppy disk, DVDs, a hard disk, a magnetic storage media, an optical recording media, or a magneto-optical disk or computer code downloaded over a network originally stored on a remote recording medium, a computer readable recording medium, or a non-transitory machine readable medium and to be stored on a local recording medium, so that the methods described herein can be rendered in such software that is stored on the recording medium using a general purpose computer, a digital computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein.

Although the invention has been shown and described with reference to certain exemplary embodiments thereof, it will be understood by those skilled in the art that various changes in form and details may be made therein without departing from the spirit and scope of the invention as defined by the appended claims and their equivalents. Therefore, the scope of the present invention should not be limited to the above-described embodiments but should be determined by not only the appended claims but also the equivalents thereof.

What is claimed is:

1. An input/output unit of a mobile terminal, the unit comprising:
a touchscreen unit comprising a display, and a combination of a resistive touch panel and a capacitive touch panel stacked on the display; and
a controller for communicating with the touchscreen unit and selectively driving one of the resistive touch panel and the capacitive touch panel depending on a predetermined circumstance of use of the mobile terminal

2. The unit of claim 1, further comprising a switching unit for switching between the resistive touch panel and the capacitive touch panel under control of the controller.

3. The unit of claim 1, further comprising a sensor unit for outputting information to the controller corresponding to a condition external to the mobile terminal,
wherein the controller identifies the predetermined circumstance depending on the information provided from the sensor unit.

4. The unit of claim 3, wherein the sensor unit outputs information regarding at least one of temperature or humidity to the controller, and the controller drives one of the resistive touch panel and the capacitive touch panel depending on a predetermined setting when the temperature or humidity information received from the sensor unit reaches a threshold.

5. The unit of claim 3, wherein the sensor unit outputs a signal regarding proximity of a conductor to the controller, and the controller drives the resistive touch panel when receiving the signal from the sensor unit.

6. The unit of claim 1, wherein the controller identifies an application in use by the mobile terminal, and the controller drives a relevant touch panel corresponding to the identified application.

7. A method for selectively driving a touch panel in a mobile terminal having a touchscreen unit comprising a display and two touch panels stacked on the display, the method comprising:
detecting a predetermined circumstance; and
driving a first touch panel, selected from the two touch panels, designated for the predetermined circumstance of use of the mobile terminal.

8. The method of claim 7, wherein the driving of the first touch panel comprises, when the first touch panel is being driven, maintaining the first touch panel as a current touch panel to be driven.

9. The method of claim 7, wherein the driving of the first touch panel comprises, if the second touch panel is currently being driven, switching to drive the first touch panel.

10. The method of claim 9, further comprising, when the predetermined circumstance ends, switching back to drive the second touch panel.

11. The method of claim 9, further comprising maintaining the first touch panel as the current touch panel being driven even when the predetermined circumstance ends.

12. The method of claim 9, wherein the two touch panels comprise a resistive touch panel and a capacitive touch panel.

13. A mobile terminal comprising:
a touchscreen unit comprising a display and two touch panels stacked on the display; and
a controller for detecting a predetermined circumstance during operation of the mobile terminal, and for selectively driving a first touch panel, selected from the two touch panels, designated for the predetermined circumstance of use of the mobile terminal

14. The mobile terminal of claim 13, wherein the controller maintains driving the first touch panel as a current touch panel to be driven.

15. The mobile terminal of claim 13, further comprising:
a switching unit;
wherein, if the second touch panel is currently being driven, the switching unit switches the controller to drive the first touch panel.

16. The mobile terminal of claim 15, wherein, when the predetermined circumstance ends, the switching unit switches back to drive the second touch panel.

17. The mobile terminal of claim 15, wherein the switching unit maintains the first touch panel as the current touch panel being driven even when the predetermined circumstance ends.

18. The mobile terminal of claim 13, wherein the two touch panels comprise a resistive touch panel and a capacitive touch panel.

19. The mobile terminal of claim 13, further comprising:
a sensor unit for outputting information to the controller corresponding to a condition external to the mobile terminal;
wherein the controller identifies the predetermined circumstance depending on the information provided from the sensor unit.

20. The mobile terminal of claim 19, wherein the sensor unit outputs information regarding at least one of temperature or humidity to the controller, and the controller drives a selected one of the two touch panels depending on a predetermined setting when the temperature or humidity information received from the sensor unit reaches a threshold.
